(19) United States
(12) Patent Application Publication
(10) Pub. No.: US 2024/0410428 A1
(43) Pub. Date: Dec. 12, 2024

(54) CLUTCH/BRAKE ASSEMBLY

(71) Applicant: Microtecnica S.r.l., Torino (IT)

(72) Inventors: Andrea MORNACCHI, Torino (IT); Elio MANTIA, Torino (IT); Vincenzo SERRICCHIO, Torino (IT); Dario SAVINO, Palazzolo Vercellese (IT); Simone ALLEVI, Appignano del Tronto (IT)

(21) Appl. No.: 18/736,941

(22) Filed: Jun. 7, 2024

(30) Foreign Application Priority Data
Jun. 9, 2023 (EP) 23425029.8

(51) Int. Cl. F16D 27/02; F16D 13/08; F16D 51/02; F16D 65/22; F16D 66/00; F16D 121/20

(52) U.S. Cl. CPC F16D 27/025; F16D 13/08; F16D 51/02; F16D 65/22; F16D 66/00; F16D 2066/003; F16D 2121/20; F16D 2300/14; F16D 2300/18; F16D 2500/1022; F16D 2500/1045

(57) ABSTRACT

A clutch/brake assembly includes: an input shaft arranged to be rotated, in use, by a motor; an output shaft configured to be rotated by the input shaft when brought into engagement therewith; rotating clutch plate elements configured to transmit torque from the input shaft to the output shaft when engaged; a logarithmic spring mounted around the input shaft; a translating shaft around the spring; an output sleeve between the output shaft and the clutch plate elements; and a solenoid connected to the translating shaft. The solenoid can be in at least two states and either cause movement of the translating shaft to compress the spring in first or second directions control the assembly.

### CROSS-REFERENCE TO RELATED APPLICATIONS

This application claims the benefit of European Patent Application No. 23425029.8 filed Jun. 9, 2023, the disclosure of which is incorporated herein by reference in its entirety.

### TECHNICAL FIELD

The present disclosure relates to a clutch/brake assembly particularly for use with an electromechanical actuator, EMA.

### BACKGROUND

Actuators are used in many applications e.g. industrial machinery, vehicles, aircraft, to move parts or surfaces. An actuator has a controller and a source of energy. One form of actuator commonly used for its simplicity, reliability and relatively low cost is a hydraulic actuator, where the energy is provided by a hydraulic fluid. Hydraulic actuators can, however, be prone to leakage, can be heavy and bulky and relatively dirty. In some industries, e.g. in aircraft and other vehicles, in recent times, there has been a move from hydraulic actuators to electromechanical actuators (EMAs).

A typical actuator includes a motor, controlled by a controller, connected by an actuator rod to an output which is connected to the part to be moved. The motor therefore drives the output based on an input command from the controller. A reducer e.g. in the form of a gear reducer assembly, is located between the motor and the output to reduce the speed from the motor to the output based on a reducer gear ratio.

In a typical EMA, a clutch/brake assembly is installed in the area with minimum torque between the motor and the gear reducer to engage/disengage the motor. Typically, the clutch is controlled to engage/disengage by a solenoid.

The transition from hydraulic actuators to EMAs, however, has required the redefinition of several components due to the different density of the power supply. One such component is the clutch/brake assembly.

Conventional friction base clutch/brake assemblies comprise a number of plates or cones that are forced into frictional engagement. These require a compressive force to be applied proportional to the torque to be transmitted. In the case of high torques, there is therefore a need for high power and heavy solenoids. A high current is also needed to generate and maintain sufficient force to transfer the torque and this can result in the generation of heat that needs to be dissipated.

In a conventional actuator as described above, the torque is lowest between the motor and the reducer, and so typically the clutch/brake assembly is installed here. This will operate to disconnect the motor from the gear reducer if required. If, however, a jam or other damage occurs in the gear reducer, downstream of the clutch, the clutch/brake assembly at this location would not respond to disconnect the output. In some applications, e.g. in aircraft control actuators, this can have catastrophic consequences. In, for example, an autopilot actuator, with a clutch/brake assembly located upstream of the reducer, a gear jam in the reducer or damage to the reducer would mean that the pilot is no longer able to control the aircraft. In such applications, therefore, safety requirements dictate that the clutch should be located downstream of the reducer—i.e. between the reducer and the output. This region of the actuator, however, is a relatively high torque region and the clutch/brake assembly needs to be configured to transmit a much higher (e.g. in the order of 20 times as much) torque. To have a conventional clutch/brake assembly located in this high torque region requires a large, heavy solenoid to provide the required force, and will also require heat dissipation solutions due to the high current requirement. These requirements add to the overall size and weight of the assembly.

There is a desire for an improved clutch/brake assembly that can operate using a smaller solenoid and that generates less heat and that can be smaller, lighter and more compact. This would be particularly useful for EMAs where the clutch is to be located in a high torque region, but could also be used in lower torque regions (although there is then a trade-off between the mechanically simpler, less expensive conventional plate structures, which may be sufficient in these low-torque regions, and the advantages in relation to size and weight of the new design).

### SUMMARY

According to the present disclosure, there is provided a clutch/brake assembly which uses a logarithmic spring in place of the conventional friction based clutch/brake assemblies comprising a number of plates or cones, allowing the assembly to be operated using a smaller solenoid than the conventional assembly. The clutch/brake assembly of this disclosure comprises: an input shaft arranged to be rotated, in use, by a motor; an output shaft configured to be rotated by the input shaft when brought into engagement therewith; rotating clutch plate elements configured to transmit torque from the input shaft to the output shaft when engaged; a logarithmic spring mounted around the input shaft; a translating shaft around the spring; an output sleeve between the output shaft and the clutch plate elements; and a solenoid connected to the translating shaft; whereby the solenoid, in a first state of energization, causes movement of the translating shaft to compress the spring in a first direction to bring the clutch plate elements and the input shaft and the output sleeve into engagement such that torque is transmitted from the input shaft to the output shaft via the spring, the clutch plate elements and the output sleeve, or, in a second state of energization, to compress the spring in a second direction such that the clutch plate elements are disengaged from the output sleeve such that torque is not transmitted between the clutch plate elements and the output shaft.

Also provided is an EMA comprising such a clutch/brake assembly.

### BRIEF DESCRIPTION OF THE FIGURES

FIG. 1 is a schematic view of an EMA assembly for the purposes of explanation.

FIG. 2 is a sectional view showing a clutch/brake assembly in an EMA assembly, according to the disclosure.

FIG. 3 is a 3D view of a clutch/brake assembly according to the disclosure.

### DETAILED DESCRIPTION

Examples of the clutch/brake assembly will now be described with reference to the drawings. It should be noted that these are examples only and variations are possible within the scope of the claims

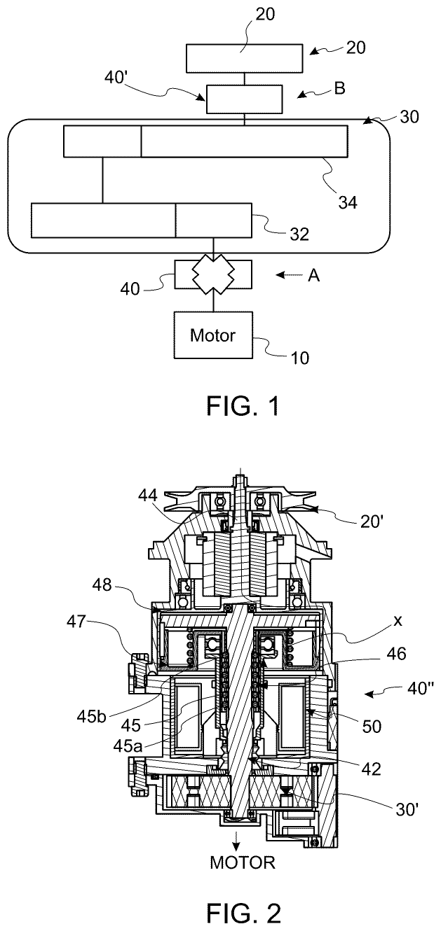

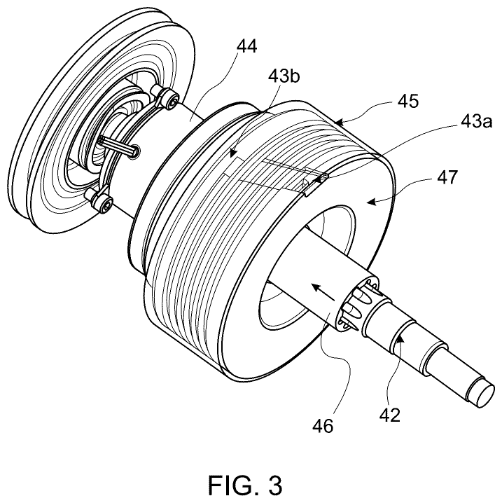

FIG. 1 is used for explaining the arrangement of a clutch/brake assembly in an EMA (as described in the Background). This will only be described briefly here.

FIG. 1 shows an EMA motor 10, controlled by an EMA controller (not shown) to drive the output 20 based on an input command, A gear reducer assembly 30 is provided between the motor 10 and the output 20. Here, the reducer 30 is shown having two gears 32, 34 to provide the speed reduction ratio, but, in practice different types and configurations of gear assembly with different numbers and types of gear are possible. Any known type of gear reducer is possible.

As mentioned above, a clutch/brake assembly is provided between the motor 10 and the output 20 to enable the output to be disengaged from/engaged with the motor. Conventionally, the clutch/brake assembly 40 is located in a low torque region A so that such a large solenoid is not needed to operate the clutch but, as mentioned about, in some applications this is not sufficient as the clutch/brake assembly will then not be operable in the case of a fault in the reducer 30. In such applications, therefore, the clutch/brake assembly 40′ has to be located downstream of the reducer 30 (region B in FIG. 1) but, because this is a higher torque region, larger solenoids are required.

The clutch/brake assembly of this disclosure, described further below, will have particular application and provide particular benefits for applications where the assembly is used in such a high-torque region, but may also be used in other regions (such as region A). Because the assembly of the present disclosure will typically be more expensive to manufacture than the conventional clutch/brake assembly, however, it may be preferable to use conventional assemblies in applications and regions where the torque is such that they can be operated with a relatively small solenoid.

FIG. 2 shows, in cross-section, a clutch/brake assembly according to this disclosure, located between the gear reducer 30′ and the output 20′. The gear reducer 30′ will not be described further and will correspond to conventional reducers such as described above with reference to FIG. 1. The gear reducer 30′ drives a rotating shaft 42 which engages with and drives an output shaft 44 that drives the output 30′. Whilst the assembly of the disclosure is described for an EMA with a gear reducer, the assembly may also be used in a direct drive system—i.e. where the motor is connected directly to the rotating shaft 42.

The clutch/brake assembly 40″ comprises a logarithmic spring 45, a translating shaft 46, rotating and translating elements 47 to engage the spring 45 and transmit torque, and an output sleeve 48 connected to the output shaft. The clutch/brake assembly is drive by a solenoid 50 to which the translating shaft 46 is connected.

The logarithmic spring 45 has a rectangular section rotating inside the output sleeve 48 and is connected to the rotating shaft 42. A logarithmic spring has a constant angle between the tangent and the radial line at any point on the radius of the spring helix. The logarithmic spring, thanks to its design, allows amplification of the ratio between the torque necessary to expand it and the torque transmitted by friction with output sleeve 48. This proportion guarantees transmission of high torques, from the reducer to the output, with a relatively reduced engagement force compared to conventional clutches/brakes. If the output sleeve 48 is solidly fitted into the body of the actuator, the spring 45 acts as a brake. If the output sleeve 48 is solidly connected to the output shaft 44, the spring provides friction. The clutch/brake is activated and released by radial expanding or contracting the spring by acting in the appropriate direction on the spring ends 45a, 45b.

In operation, as the motor drives the rotating shaft 42, via the reducer 30′, and when the solenoid 50 is in a state energised to engage the clutch, the solenoid causes a displacement of the translating shaft 46 that is pressed against the rotating and translating shaft 47. Rotating and translating shaft 47 acts on the first end 45a of the spring causing the radial expansion of the spring 45 which engages with the sleeve 48. The friction between the spring 45 and the output sleeve 48 generated by the expansion of the spring 45, allows the transfer of the torque generated by the motor and transmitted to the clutch via the rotating shaft 42 to the output sleeve 48 which transmits torque to the output via output shaft 44. The torque is transmitted to the spring 45 through the spring tooth 43b

When the solenoid is in a state non-energised to disengage the clutch, the torque generated by stiffness of the logarithmic spring acts through the spring tooth 43a on the rotating and translating shaft 47. The torque results in an axial force along the axis of the rotating and translating shaft 47 thanks to the inclined plane of the interface between the spring tooth 43a and rotating and translating shaft 47. The axial force pushes the rotating and translating shaft 47 against the translating shaft 46 that causes the moving element of the solenoid to return to its de-energized condition. The translation of the moving elements 47 and 46 allows the spring to return to its rest condition and therefore to restore the radial gap between the spring 45 and the output sleeve 48 disconnecting the gearbox from the output and allowing the free rotation of the output 20.

The rotating and translating shaft (clutch elements 47) may be coupled to the input shaft such that it rotates with the input shaft and is also able to translate linearly relative to the input shaft. The coupling may be by any means that ensures torque transfer and also relative movement between the coupled parts, e.g. a linear bearing, ball bearings, splines, key features, a D-shaft or the like.

Operation of the clutch is therefore caused by the spring radial expansion and the solenoid only needs to be strong enough to counteract the spring stiffness. The force of the clutch is therefore not directly related to the force applied, as it is in conventional assemblies in which the solenoid has to provide the force directly to compress the clutch plates.

Position sensors (not shown) may be provided in the assembly to indicate the position (and therefore state of engagement) of the clutch assembly. Various known types of sensor e.g. Hall sensors, mechanical switches etc. may be used.

Similarly, position sensors (not shown) may be provided in the assembly to indicate the position (and therefore state of energisation) of the solenoid. Various known types of sensor e.g. Hall sensors, mechanical switches etc. may be used.

The example here shows the clutch/brake assembly located between the reducer and the output, but the concept is also applicable to the assembly located in other regions of the EMA.

Using the logarithmic spring as the clutch, rather than the linear arrangement of plates compressed by a solenoid, the force required by the solenoid is substantially (around 5 times) less than for a conventional assembly. This results in a smaller, lighter assembly and reduced need for current absorption and heat dissipation.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is not intended that the present disclosure be limited to the particular embodiment disclosed as the best mode contemplated for carrying out this present disclosure, but that the present disclosure will include all embodiments falling within the scope of the claims.

1. A clutch/brake assembly comprising:
an input shaft arranged to be rotated, in use, by a motor;
an output shaft configured to be rotated by the input shaft when brought into engagement therewith;
rotating clutch plate elements configured to transmit torque from the input shaft to the output shaft when engaged;
a logarithmic spring mounted around the input shaft;
a translating shaft around the spring;
an output sleeve between the output shaft and the clutch plate elements; and
a solenoid connected to the translating shaft;
wherein the solenoid, in a first state of energization, causes movement of the translating shaft to compress the spring in a first direction to bring the clutch plate elements and the input shaft and the output sleeve into engagement such that torque is transmitted from the input shaft to the output shaft via the spring, the clutch plate elements and the output sleeve;
wherein the solenoid, in a second state of energization, causes movement of the translating shaft to compress the spring in a second direction such that the clutch plate elements are disengaged from the output sleeve such that torque is not transmitted between the clutch plate elements and the output shaft.

2. The assembly of claim 1, wherein the solenoid is a normally disengaged solenoid, and wherein the first state of energisation is energised and the second state of energisation is de-energised.

3. The assembly of claim 1, wherein the solenoid is a normally engaged solenoid, and wherein the first state of energisation is de-energised and the second state of energisation is energised.

4. The assembly of claim 1, wherein the spring has a first spring tooth arranged to transfer torque from the stiffness of the spring to the rotating clutch elements when the solenoid is in the second state of energisation.

5. The assembly of claim 1, wherein the spring has a second spring tooth arranged to transfer torque from the input shaft to the spring and to the output sleeve when the solenoid is in the first state of energisation.

6. The assembly of claim 1, wherein the rotating clutch plate elements are coupled to rotate with the input shaft and are also arranged to translate linearly with respect to the input shaft.

7. The assembly of claim 6, wherein the rotating clutch plate elements are coupled to the input shaft by means of: a linear bearing, a ball bearing and groove assembly, splines, key features, or a D-shaft.

8. An electromechanical actuator, EMS, comprising:
a motor;
an output driven by the motor; and
a clutch/brake assembly as claimed claim 1 located between the motor and the output.

9. The EMA of claim 8, further comprising a gear reducer located between the motor and the output.

10. The EMA of claim 9, wherein the clutch/brake assembly is positioned between the gear reducer and the output.

11. The EMA of claim 8, further comprising:
position sensing means to detect a status of engagement or disengagement of the clutch/brake assembly.

12. The EMA of claim 8, further comprising:
position sensing means to detect a status of the solenoid.
